(19) United States
(12) Patent Application Publication
(10) Pub. No.: US 2011/0216063 A1
(43) Pub. Date: Sep. 8, 2011

(54) LIDAR TRIANGULAR NETWORK COMPRESSION

(75) Inventor: John Hayes, Seattle, WA (US)

(73) Assignee: CELARTEM, INC., Seattle, WA (US)

(21) Appl. No.: 12/719,810

(22) Filed: Mar. 8, 2010

(51) Int. Cl. G06T 17/20

(52) U.S. Cl. 345/423

(57) ABSTRACT

Using LIDAR technology, terabytes of data are generated which form massive point clouds. Such rich data is a blessing for signal processing and analysis but is also a blight, making computation, transmission, and storage prohibitive. The disclosed subject matter includes a technique to convert a point cloud into a triangular network permitting users to query spatial distance between points at different levels while facilitating compression that is nearly lossless.

### BACKGROUND

LIDAR is one of a few technologies available today that can produce a high-density elevation point cloud desirable for many topographic mapping applications. A point cloud is a set of points in a multiple-dimensional coordinate system. These points are generated over time and usually defined at least by x, y, and z coordinates, and can be numbered in the billions. Although it is easier to process these points in the time dimension, users of the LIDAR point cloud are not usually interested in the time domain, but instead are more interested in the spatial domain in which their topographic mapping applications are classified.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect includes a system form of the present subject matter which recites a system for compressing a point cloud. The system comprises a triangular network processor configured to receive points of the point cloud, and further configured to create one or more levels of a triangular network by forming active lists of triangles. Each subsequent level is formed from dividing triangles of a prior level. The system further comprises a bit-plane encoder configured to receive the triangular network to build bit planes that include a context stream, a bit stream, and plane layout to encode a compressed point cloud.

Another aspect includes a method form of the subject matter which recites a method for compressing a point cloud. The method comprises transforming points of the point cloud into a triangular network that includes levels of triangles. Each subsequent level is formed from dividing triangles of a prior level. The method further comprises compressing using bit-plane encoding to extract from the triangular network a context stream, a bit stream, and plane layout to encode a compressed point cloud.

A further aspect includes a computer-readable medium form of the subject matter which recites a non-transitory computer-readable medium on which computer-executable instructions are stored to implement a method for compressing a point cloud. The method comprises transforming points of the point cloud into a triangular network that includes levels of triangles. Each subsequent level is formed from dividing triangles of a prior level. The method further comprises compressing using bit-plane encoding to extract from the triangular network a context stream, a bit stream, and plane layout to encode a compressed point cloud.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating exemplary hardware components to compress and decompress a point cloud using a triangular network in accordance with one embodiment of the present subject matter;

FIG. 2A is a pictorial diagram illustrating an archetypical point cloud representation in accordance with one embodiment of the present subject matter;

FIG. 2B is a pictorial diagram illustrating an archetypical, bounded point cloud representation in accordance with one embodiment of the present invention;

FIG. 2C is a pictorial diagram illustrating a bounded point cloud representation on which an archetypical triangular network has been imposed in accordance with one embodiment of the present subject matter;

FIG. 2D is a pictorial diagram illustrating a bounded point cloud representation on which an archetypical triangular network has been imposed in accordance with one embodiment of the present subject matter;

FIG. 2E is a pictorial diagram illustrating a portion of the triangular network in accordance with one embodiment of the present subject matter;

FIG. 3A is a pictorial diagram illustrating a graph in accordance with one embodiment of the present subject matter;

FIG. 3B is a pictorial diagram illustrating a graph in accordance with one embodiment of the present subject matter;

FIGS. 4A-4K are process diagrams illustrating a method for compressing a point cloud in accordance with one embodiment of the present subject matter; and

FIGS. 5A-5B are process diagrams illustrating a method for decompressing so as to recover a point cloud in accordance with one embodiment of the present subject matter.

### DETAILED DESCRIPTION

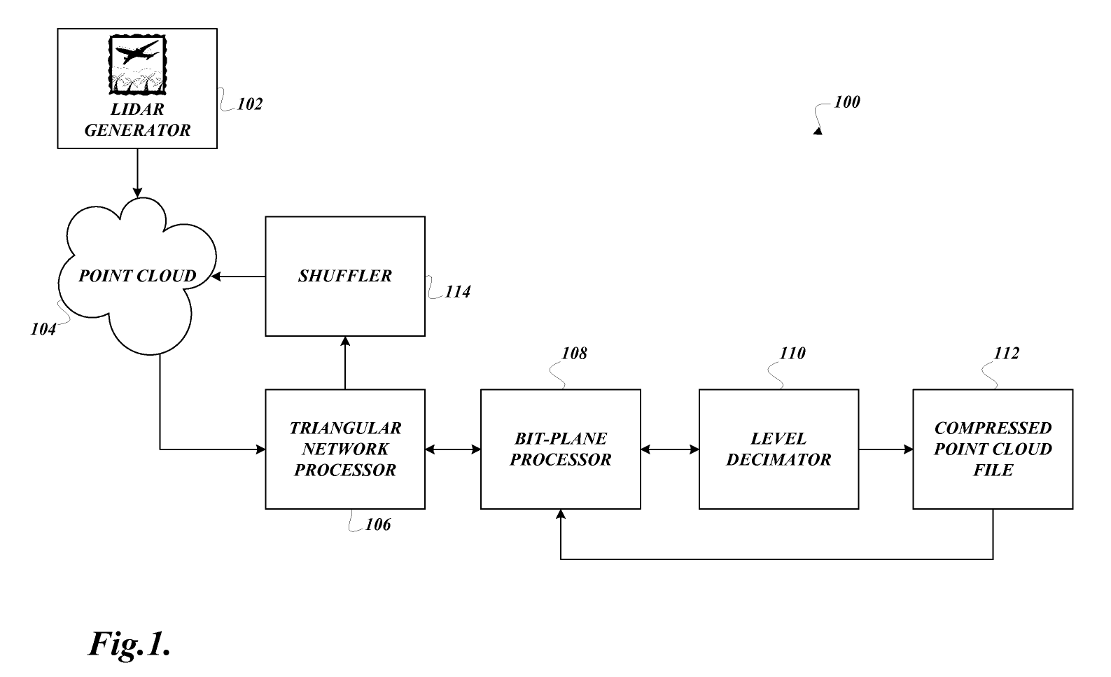

FIG. 1 illustrates a system 100 configured to compress and/or decompress a point cloud 104 produced by a LIDAR generator 102. Components of the system 100 include hardware components, such as one or more computers, standing alone or networked, on which one or more pieces of software execute. The etymology of LIDAR (hereinafter referred to as “lidar”) traces its development to “light detection and ranging,” which is an optical remote sensing technology that measures properties of scattered light to find range and/or other information of distant targets. The conventional method to sense distance targets is to use laser pulses. Unlike radar technology, which uses radio waves, consisting of light that is not in the visible spectrum, lidar's point cloud 104 is accumulated by the transmission of laser pulses and the detection of the reflected signals.

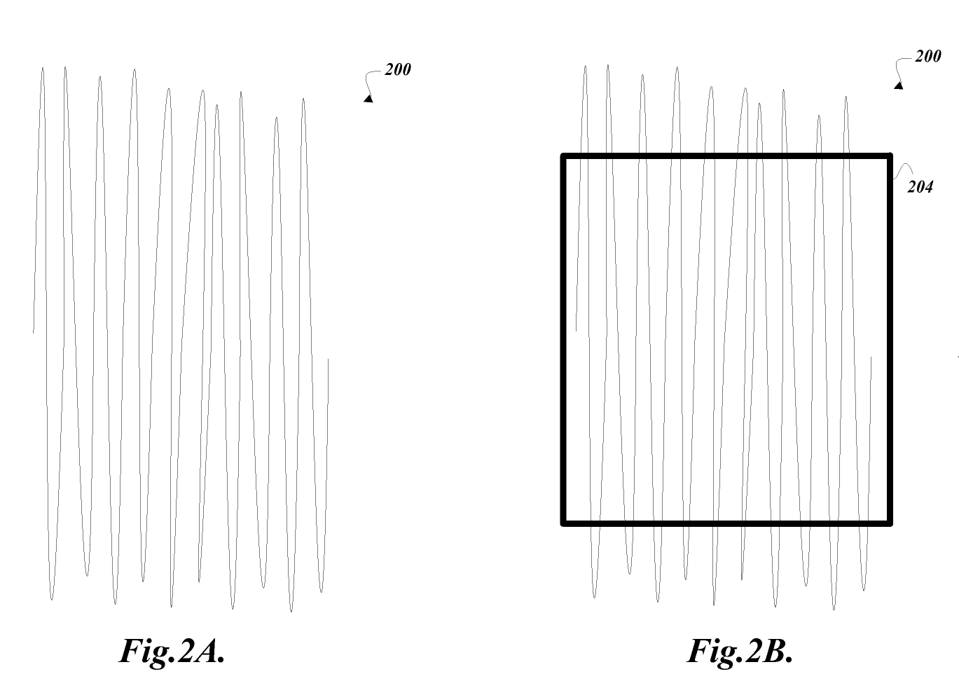

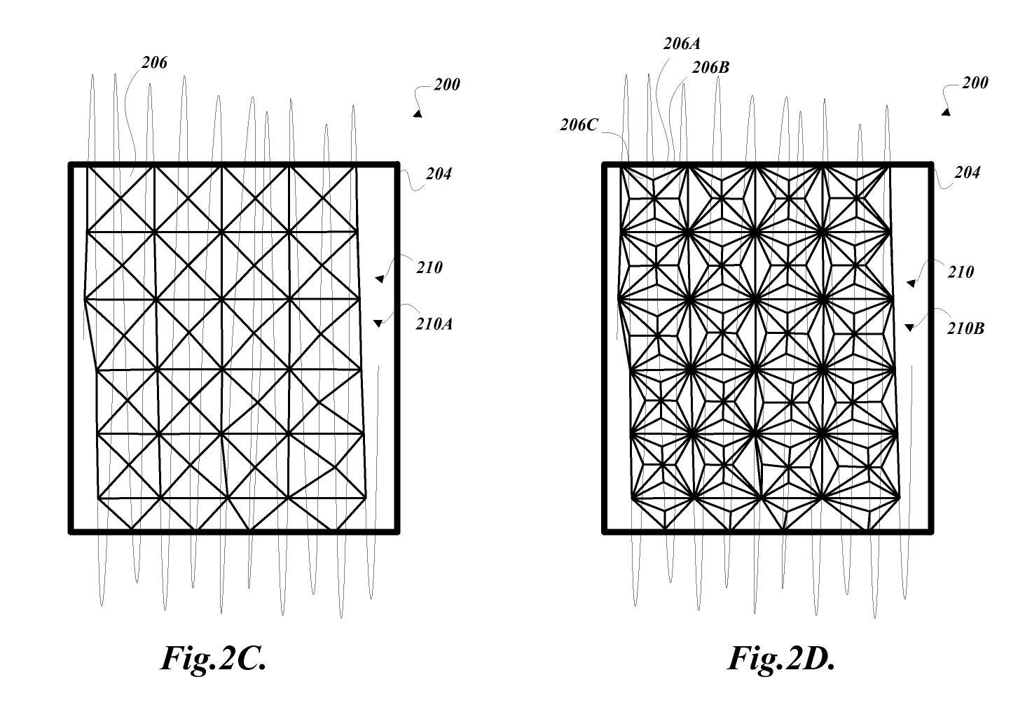

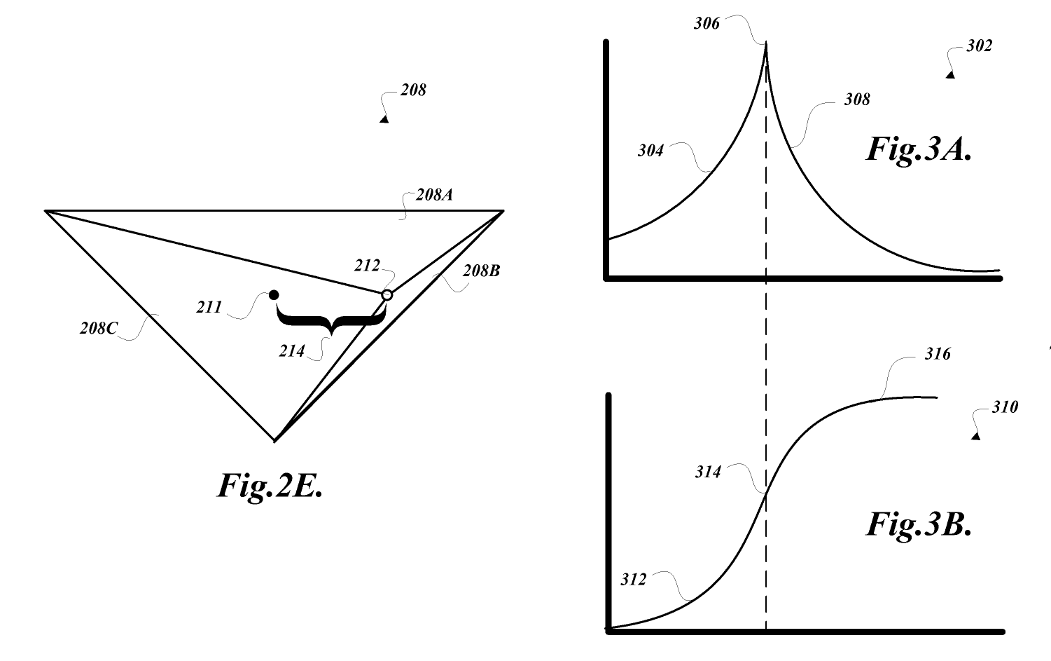

The lidar generator 102 comprises a laser placed on an aircraft that points toward a geographic region of interest. Incident laser pulses are directed toward the geographic region of interest while the aircraft undulates in a wavy, sinuous, or flowing manner. (See a distribution of a point cloud at FIG. 2A as an example.) The incident laser pulses eventually strike targets in the geographic region causing reflected signals to return immediately if they strike sufficiently opaque targets, such as a rock, and a bit later if they strike sufficiently transparent targets, such as leaves on a tree. Thus, for one incident laser pulse, there may be one or more reflected signals that are sensed by the aircraft. The reflected signal that returns first may have an intensity stronger than those reflected signals that return later.

In addition, a minor toward which the laser points sweeps back and forth, causing the laser to send incident laser pulses that correspondingly sweep back and forth as the aircraft flies above the geographic region of interest. A tuple is formed from several dimensions to contribute to the point cloud 104, such as an ordinal reference that is indicative of the order in which the data of a vector was collected, locations (X, Y, and Z), time, intensity, the number of reflected signals that return, the numerical reference of a particular reflected signal that returns, and so on. Many other suitable dimensions are possible in addition to those mentioned here. Millions or even billions of tuples may be formed as the aircraft travels above the geographic region of interest. This multitude of tuples creates a point cloud that is very large making computation, transmission, and storage difficult.

The point cloud 104 is presented to a triangular network processor 106. The triangular network processor 106 transforms the point cloud 104 into a network of triangles from the point cloud 104 by forming a web of open texture with periodically spaced triangles representing one or more levels of the point cloud 104. Recall that the point cloud 104 represents a geographic region of interest. Each level of the triangular network provides a pictorial representation of the geographic region of interest with the highest level including a network with a small amount of triangles, while the lowest level includes a network with many triangles. As a result, the triangular network processor 106 not only provides a processed point cloud for compression but also provides levels of resolution of the geographic region of interest where a user can query the spatial length of two points of the point cloud in the triangular network at a particular level.

As an illustrative example, assume that the geographic region of interest is a flood plain. A plane flies over the flood plain and obtains a lidar point cloud that represents the flood plain. The triangular network processor 106 creates levels of resolution of the flood plain to allow a user, such as a government agency or an insurance company, to visually inspect the flood plain at any desired levels of resolution. The user may query to obtain the spatial length of points at a level of resolution to analyze geographic features. For example, a government agency may want to know whether a planned community would be built in a flood plain or not using the contour information provided by the levels of resolution of the triangular network and queries of the spatial distances of points.

The triangular network transformation suitably aids a bit-plane processor 108 by presenting to it the processed point cloud, which leads to entropic compression of the point cloud 104. To further reduce the bit-plane-encoded point cloud in size for facilitating computation, transmission, or storage, the bit-plane-encoded point cloud is presented to a level decimator 110. Depending on the desired size of the compressed point cloud file 112 for computation, transmission, or storage, as specified by the user of the system 100, further compression is achieved by decimating one or more levels of the bit-plane-encoded point cloud by the level decimator 110. Suitably, the lower levels of the bit-plane-encoded point cloud are decimated before decimating the higher levels (or upper levels) to obtain the desired size.

The decompression process receives the compressed point cloud file 112 and prepares for decompression by the bit-plane processor 108. Structurally, the decompression process is similar to the compression process previously described. The compressed point cloud file 112 is presented to decoding at the end of which the original channels are reconstituted. Because the reconstituted data may appear as an annoying pattern to users, the triangular network processor 106 uses a shuffler 114 so as to reduce or eliminate such a pattern. The pattern may arise because the encoding process produces active triangle lists whose points populate a display in the pattern from the encoding route from which they were created. Some of the active triangles may be removed by the level decimator 110 to obtain a desired compression ratio, and such removed active triangles leave behind active triangles in a pattern. The shuffler 114 shuffles, selects, assigns, or arranges the active triangles that were not decimated so as to reduce or eliminate a pattern visually noticeable to the user.

FIG. 2A illustrates a point cloud whose distribution mirrors movement of the aircraft over the region of geographical interest. Numerous, albeit less uniform, spaced points are generated near the cusps or points of transition of the distribution. More uniformly spaced points are generated in the center of the distribution. To focus processing on the more uniformly spaced points, the triangular network processor places a convex hull 204 to capture a suitable number of uniformly spaced points, such as about 1,000 points, encompassing the center of the distribution of the point cloud 104. See FIG. 2B.

FIG. 2C illustrates a first level 210A of a triangular network 210 formed from the web of open texture with periodically spaced triangles. Each triangle is suitably an equilateral triangle if there are points within a proximity on the point cloud that support the construction of the equilateral triangle. To start, the triangular network processor 106 selects any suitable point as the first vertex of a first equilateral triangle 206 of the first level 210a of the triangular network 210. In an archetypical instance, the triangular network processor 106 selects a point on the point cloud within the convex hull 204 at the upper left corner. To find the two other vertices of the first equilateral triangle, the triangular network processor 106 calculates a searching radius. Any searching radius may be used. One suitable searching radius includes a square root of a quotient, the dividend of which is the number of points bound by the convex hull 204 and the divisor of which is the area of the convex hull 204.

Using the searching radius radiating from the first vertex, the triangular network processor 106 finds a point on the point cloud that represents the second vertex, and another point on the point cloud that represents the third vertex of the first equilateral triangle. After the vertices are found, edges emanate from the vertices to form the first equilateral triangle. Using one of the vertices of the first equilateral triangle, the triangular network processor 106 repeats the process to build a second equilateral triangle and so on until the first level of the triangular network is formed. Because of the calculated searching radius, the spatial length between samples or vertices or points of the first level of the triangular network is known. This can be provided to users who query for such information. The first level provides a coarse pictorial representation of the geographic region of interest. Finer pictorial representations are possible with lower levels of the triangular network formed from greater numbers of points, and hence greater numbers of triangles.

FIG. 2D illustrates another level 210B of the triangular network 210, which is one lower than the level 210A illustrated in FIG. 2C. The triangles of the upper, coarser level 210A are populated with more triangles to form the lower, finer level 210B. The triangular network processor 106 populates more triangles by dividing each triangle of the upper, coarser level 210A into additional triangles if possible. As an illustration, the triangular network processor 106 calculates a center of mass for the triangle 206 of the upper, coarser level 210A. The center of mass indicates where an ideal point should be located for equitable division of the triangle 206.

Because the distribution of the point cloud 104 may not include a point at the center of mass of the triangle 206, the triangular network processor 106 searches for the closest point on the distribution of the point cloud 104 to the center of mass of the triangle 206. This located point becomes a vertex shared by the additional triangles. In other words, after this vertex is found, edges emanate from the vertex to terminate at the vertices of the triangle 206 to create the additional triangles 206A, 206B, 206C. This process is repeated until the triangles of the upper, coarser level 210A have been processed by the triangular network processor 106 to create the lower, finer level 210B. This process is repeated again to create another level that is lower and finer than the level 210B. For example, the triangular network processor 106 finds a center of mass for the triangle 206A, locates a point on the distribution of the point cloud 104 within the triangle 206A that can be used to further divide the triangle 206A, and so on.

FIG. 2E illustrates a triangle 208 taken from the triangular network 210. To split the triangle 208 to form another layer for the triangular network 210, a center of mass 211 is calculated for the triangle 208. Because the calculated center of mass 211 may not identify a point located in the point cloud distribution 200, the closest point 212 on the point cloud distribution 200 is suitably located, which becomes a common vertex to create triangles 208A, 208B, and 208C from the triangle 208. A deviation 214 is the length difference between the calculated center of mass 211 and the located point 212, which is stored, and is presented in the bit-plane-encoding process to compress the point cloud distribution 200 as represented by the triangular network 210.

FIG. 3A, 3B illustrate two graphs whose x-axis represents levels of the triangular network 210. The y-axis of the graph illustrated by FIG. 3A represents numbers of points added or inserted into the triangular network at each level. The y-axis of the graph illustrated by FIG. 3B represents numbers of points in the triangular network or the number of triangles at each level. Curve 302 illustrates that each subsequent level uses more points to form triangles than prior levels. See portion 304. For example, a level marked in the middle of the portion 304 uses more numbers of points in comparison to number of points used by an initial level as marked by the portion 304. After the apex 306 is reached, each subsequent level has fewer points available to form vertices of triangles. See portion 308. This can be explained that as the triangular network 210 consumes points (on the distribution of the point cloud 104) fewer and fewer points are available for participating in triangle formation. In other words, the portion 308 looks like a long tail because the input data (of the point cloud 104) is not uniformly spaced and the more uniform the input data is the steeper and shorter the portion 308 will be.

Curve 310 illustrates that each level of the triangular network contains more and more points used to create more and more triangles. Portion 312 shows a fast growth of points with each successive level. Beginning at an inflection point 314, slower growth is seen as there are fewer and fewer points available for participating in triangle formation. A dashed line suggests a relationship between the apex 306 of the curve 302 and the inflection point of the curve 310. The curve 310 suggests that level decimation of the triangular network is possible while maintaining suitable representation of the point cloud depending on the desired size of the compressed point cloud file 112.

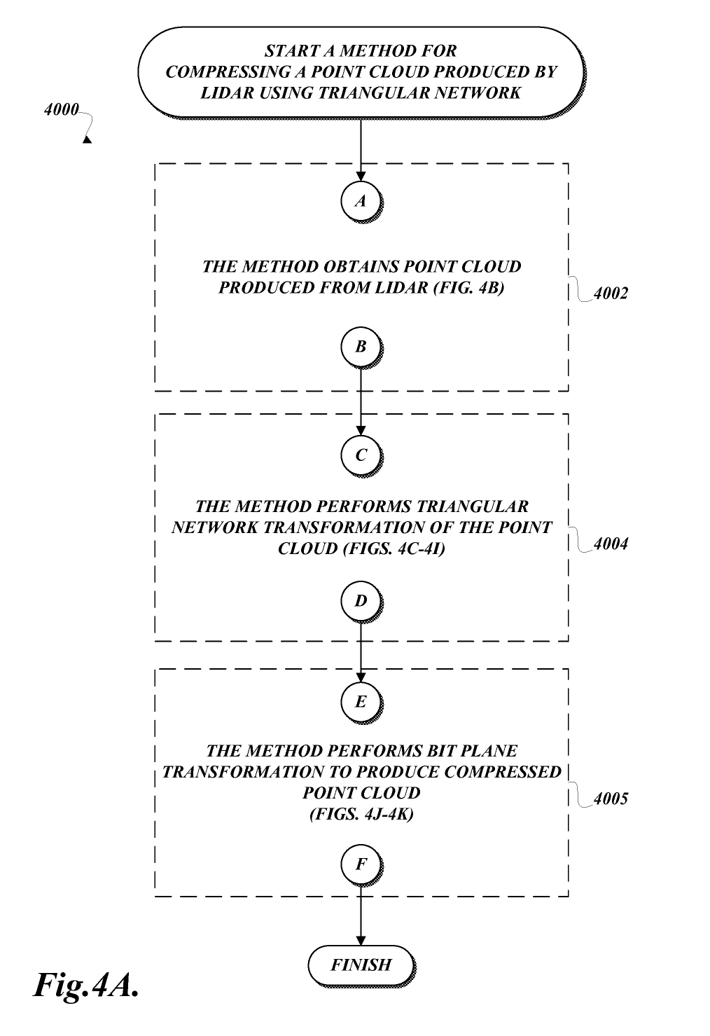

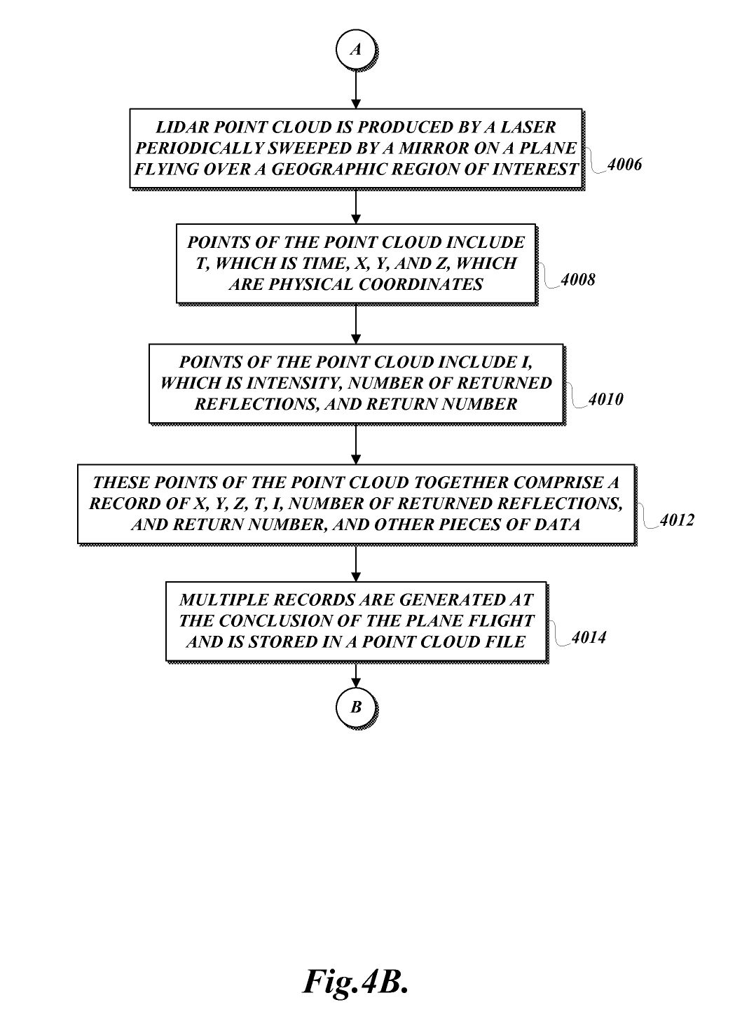

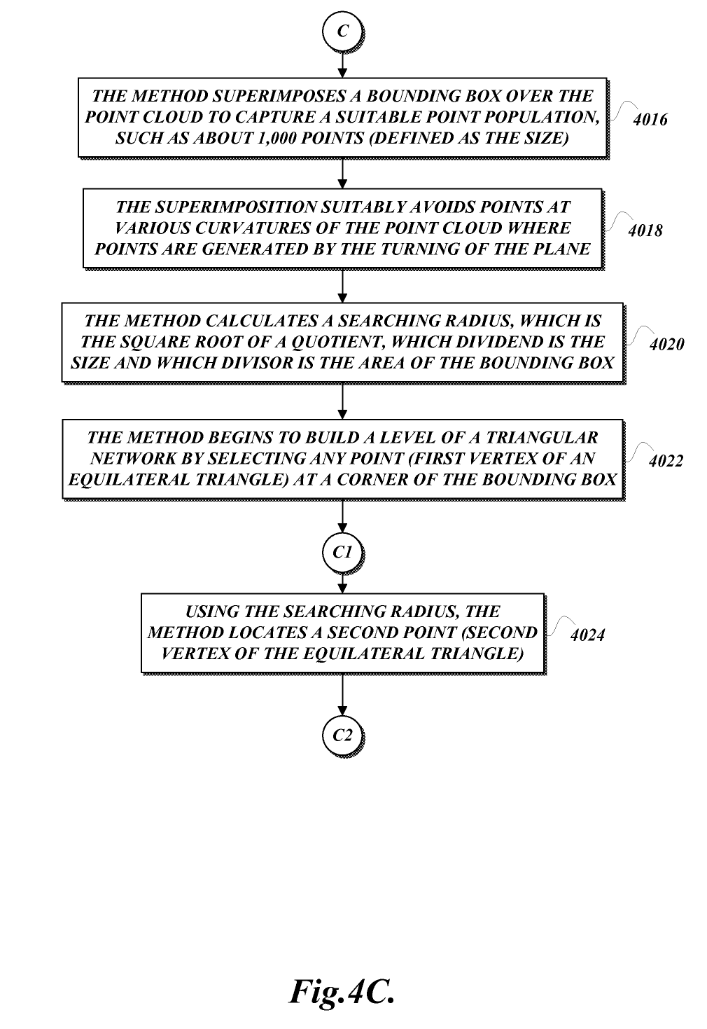

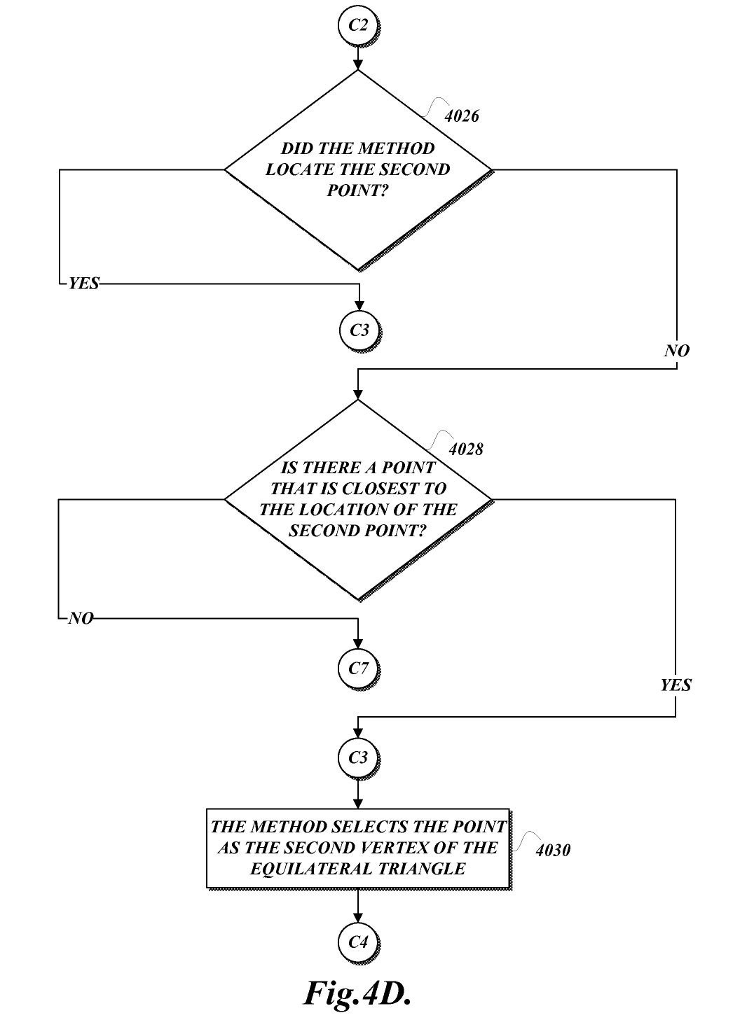

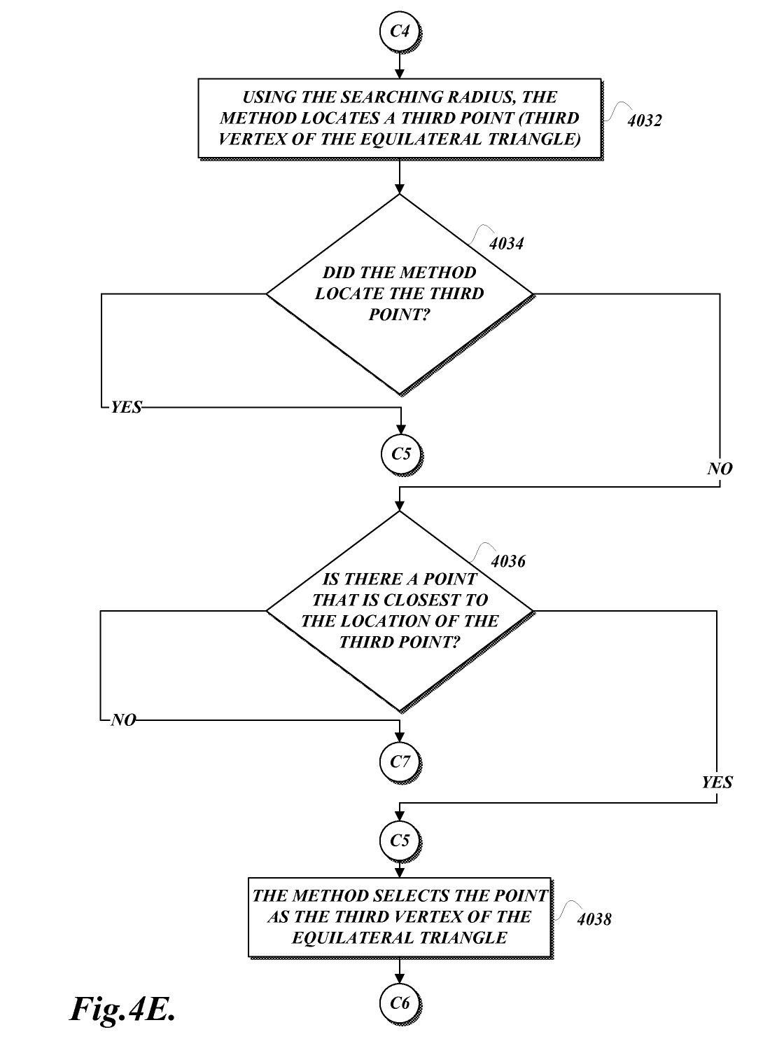

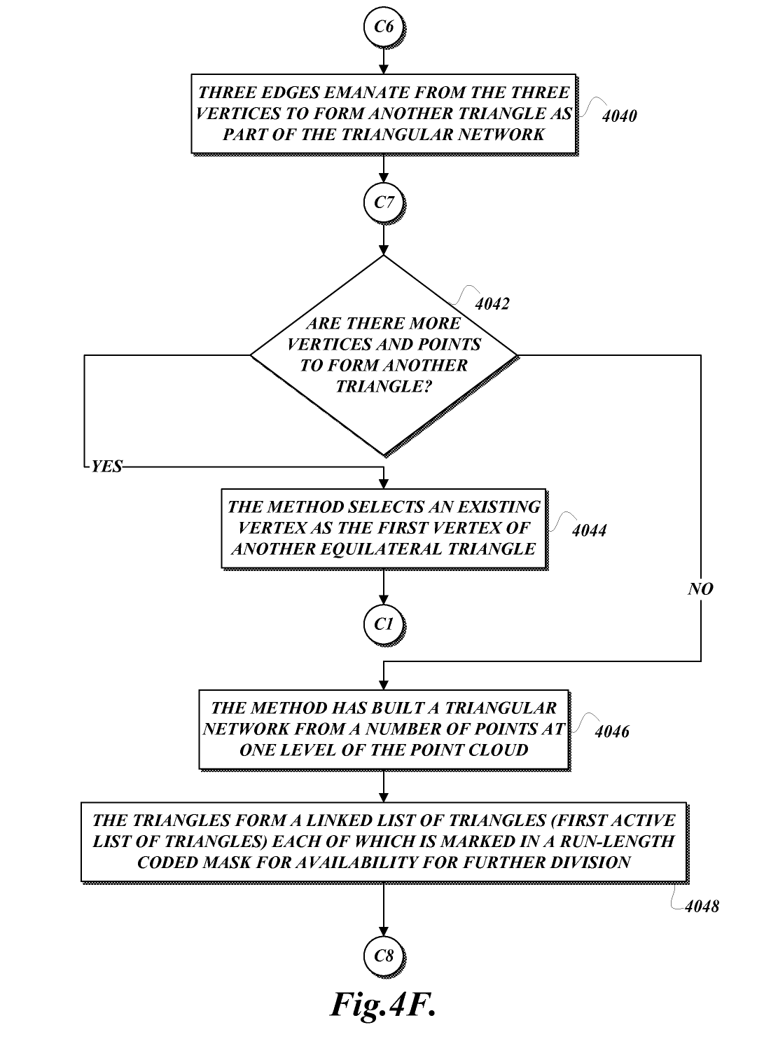

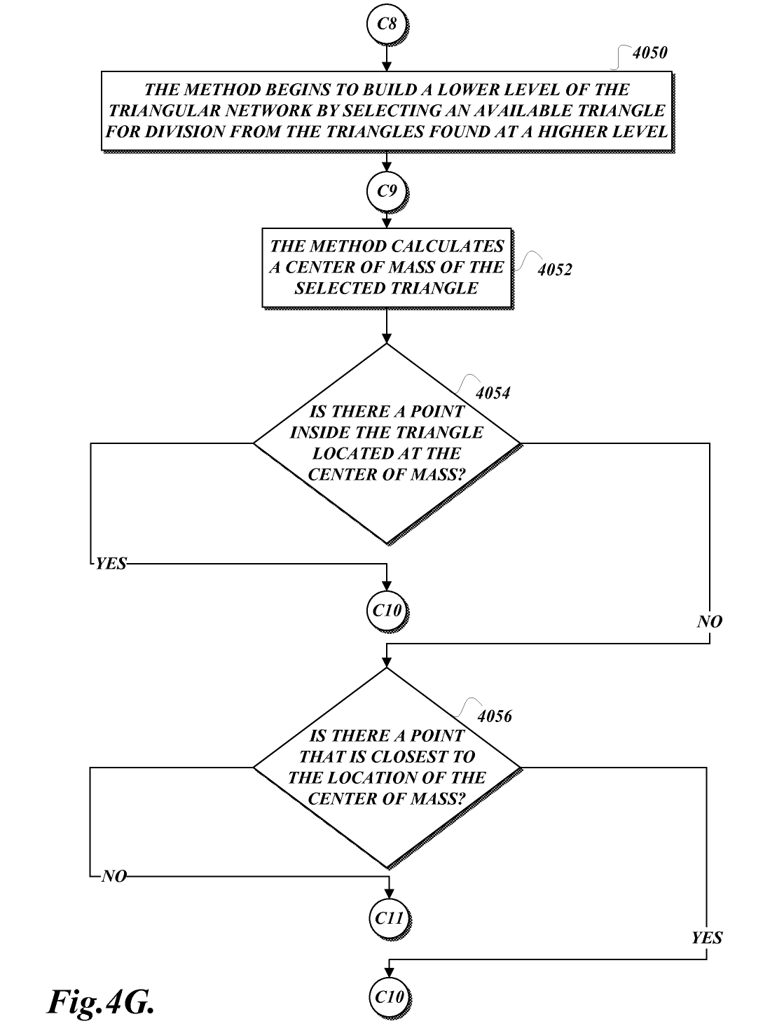

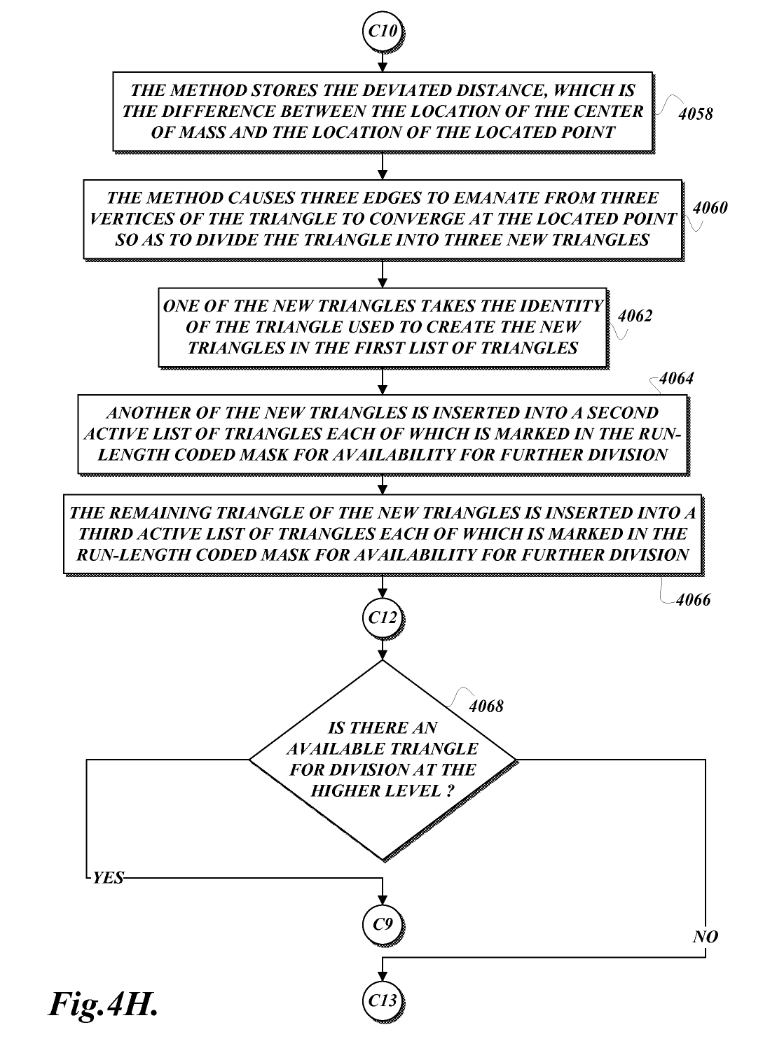

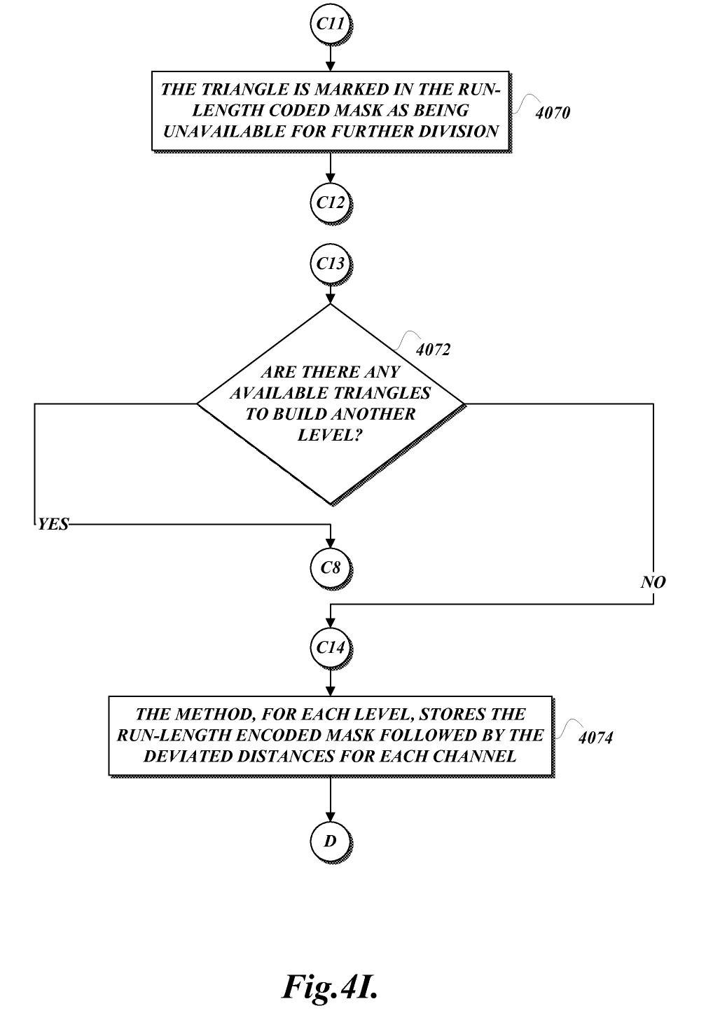

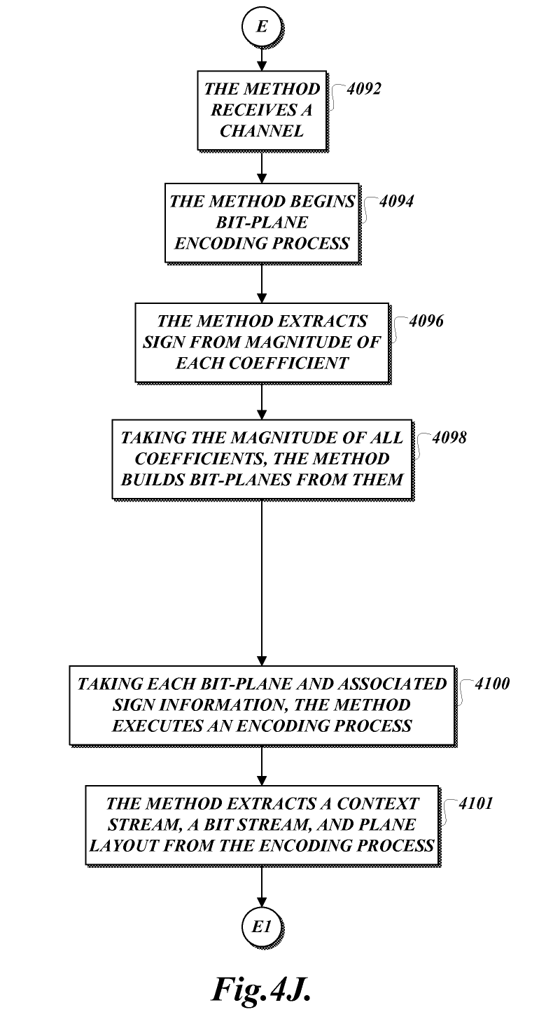

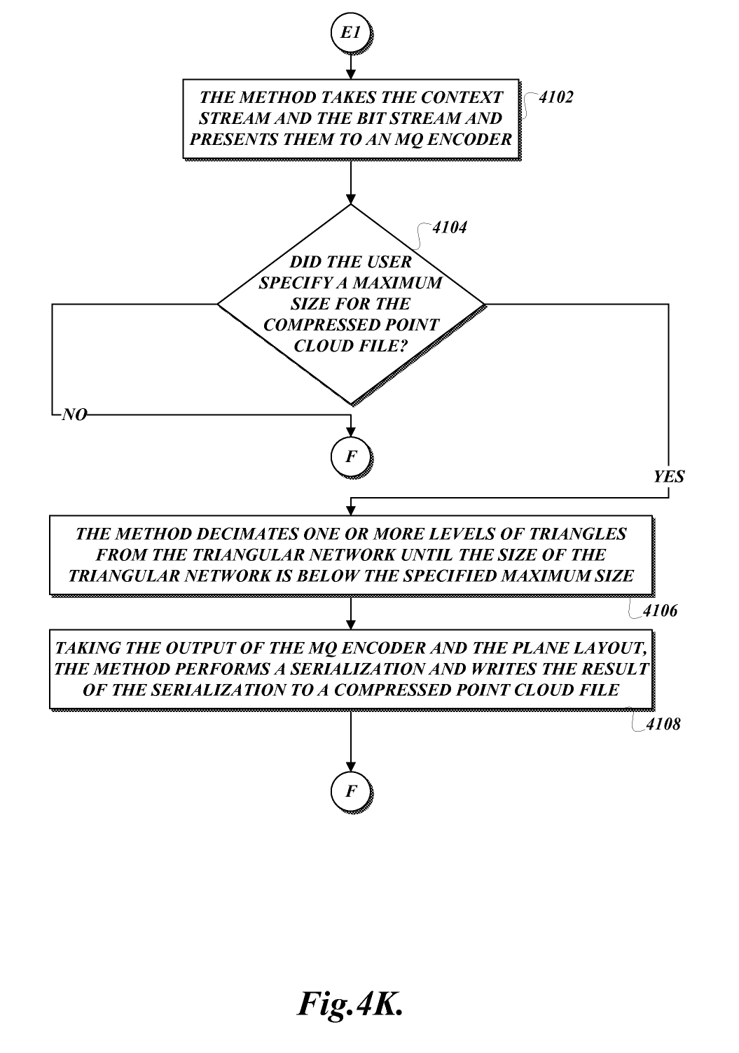

FIGS. 4A-4K illustrate a method 4000 for compressing a point cloud produced by lidar technology using a triangular network. From a start block, the method 4000 proceeds to a set of method steps 4002, defined between a continuation terminal (“Terminal A”) and an exit terminal (“Terminal B”). The set of method steps 4002 describes the execution of a set of steps to obtain the point cloud produced from lidar. See FIG. 4B.

From Terminal A (FIG. 4B), the method 4000 proceeds to block 4006 where a lidar point cloud is produced by a laser periodically sweeping by a mirror on an aircraft flying over a geographic region of interest. At block 4008, the pieces of the point cloud include T, which is time; and X, Y, and Z, which are physical coordinates. The method then proceeds to block 4010 where further pieces of data are collected, including intensity, which is I, number of returned signals, and a returned reference associated with a returned signal. At block 4012, these pieces of the point cloud together comprise a record of X, Y, Z, T, I, number of returned signals, and returned number, as well as other pieces of data, such as ordinance reference which indicates an order in which the vector or record containing these pieces of data was generated. These multiple records are stored in a point cloud file. See block 4014. The method then continues to another continuation terminal, terminal B.

From Terminal B (FIG. 4A), the method proceeds to a set of method steps 4004, defined between a continuation terminal (“Terminal C”) and an exit terminal (“Terminal D”). The set of method steps 4004 describes the execution of triangular network transformation of the point cloud. See FIGS. 4C-4I. From Terminal C (FIG. 4C), the method proceeds to block 4016 where the method superimposes a bounding box or a convex hull over the point cloud to capture a suitable point population, such as about 1,000 points, which is defined as the size. The superimposition suitably avoids points at various curvatures of the point cloud where points are generated by the turning of the plane.

The method then calculates a searching radius, which is the square root of a quotient, the dividend of which is the size and the divisor of which is the area of the bounding box. See block 4020. At block 4022, the method begins to build a level (one among many levels) of a triangular network by selecting any point (first vertex of an equilateral triangle) at a corner of the bounding box. The method then continues to another continuation terminal (“Terminal C1”). Proceeding to block 4024, the method uses the searching radius to locate a second point (second vertex of the equilateral triangle). The method then continues to another continuation terminal (“Terminal C2”).

From Terminal C2 (FIG. 4D), the method proceeds to decision block 4026 where a test is performed to determine whether the method locates the second point. If the answer to the question at decision block 4026 is yes, the method proceeds to another continuation terminal (“Terminal C3”). Otherwise, if the answer to the test at decision block 4026 is no, the method proceeds to yet another decision block 4028 where another test is performed to determine whether there is a point that is closest to the location of the second point. If the answer to the test at decision block 4028 is no, the method continues to another continuation terminal (“Terminal C7”). Otherwise, if the answer to the test at decision block 4028 is yes, the method continues to Terminal C3 where it further continues to block 4030 where the method selects the point as the second vertex of the equilateral triangle. The method then proceeds to another continuation terminal (“Terminal C4”).

From Terminal C4 (FIG. 4E), the method proceeds to block 4032 where, using the searching radius, the method locates a third point (third vertex of the equilateral triangle). Proceeding to decision block 4034, a test is performed to determine whether the method located the third point. If the answer to the test at decision block 4034 is yes, the method continues to another continuation terminal (“Terminal C5”). Otherwise, if the answer to the test at decision block 4034 is no, the method continues to decision block 4036 where another test is performed to determine whether there is a point that is closest to the location of the third point. If the answer to the test at decision block 4036 is no, the method continues to Terminal C7. Otherwise, if the answer to the test at decision block 4036 is yes, the method continues to Terminal C5 and further continues to block 4038 where the method selects the point as the third vertex of the equilateral triangle. The method then continues to another continuation terminal (“Terminal C6”).

From Terminal C6 (FIG. 4F), the method proceeds to block 4040 where three edges emanate from the three vertices to form another triangle as part of the triangular network. The method then continues to Terminal C7 and further proceeds to decision block 4042 where a test is performed to determine whether there are more vertices and points to form another triangle. If the answer to the test at decision block 4042 is yes, the method continues to block 4044 where the method selects an existing vertex as the first vertex of another equilateral triangle. The method then continues to Terminal C1 and skips back to block 4024 where the above-described processing steps are repeated. Otherwise, if the answer to the test at decision block 4042 is no, the method continues to block 4046 where the method has built a triangular network from a number of points at one level of the point cloud. At block 4048, the triangles form a linked list of triangles (first active list of triangles), each of which is marked in a run-length-coded mask for availability for further division. The method then continues to another continuation terminal (“Terminal C8”).

From Terminal C8 (FIG. 4G), the method begins to build a lower level of the triangular network by selecting an available triangle for division from the triangles found at a higher level. See block 4050. The method continues to another continuation terminal (“Terminal C9”). The method then further proceeds to block 4052 where the method calculates a center of mass of the selected triangle. Next, at decision block 4054, a test is performed to determine whether there is a point inside the triangle located at the center of mass. If the answer to the test at decision block 4054 is yes, the method continues to another continuation terminal (“Terminal C10”). Otherwise, if the answer to the test at decision block 4054 is no, the method continues to another decision block 4056 where another test is performed to determine whether there is a point that is closest to the location of the center of mass. If the answer to the test at decision block 4056 is no, the method continues to another continuation terminal (“Terminal C11”). Otherwise, if the answer to the test at decision block 4056 is yes, the method continues to Terminal C10.

From Terminal C10 (FIG. 4H), the method proceeds to block 4058 where the method stores the deviated distance, which is the difference between the location of the center of mass and the location of the located point. At block 4060, the method causes three edges to emanate from three vertices of the triangle to converge at the located point so as to divide the triangle into three new triangles. One of the new triangles takes the identity of the triangle used to create the new triangles in the first list of triangles. See block 4062.

At block 4064, another of the new triangles is inserted into a second active list of triangles, each of which is marked in the run-length-coded mask for availability for further division. The remaining triangle of the new triangles is inserted into a third active list of triangles, each of which is marked in the run-length-coded mask for availability for further division. See block 4066. These three active lists of triangles facilitate minimization of storage connected with storing triangles, and further facilitate processing efficiency as the triangles are in a particular order. The method then continues to another continuation terminal (“Terminal C12”). The method then further proceeds to decision block 4068 where a test is performed to determine whether there is an available triangle for division at the higher level. If the answer to the test at decision block 4068 is yes, the method continues to Terminal C9 and skips back to block 4052 where the above-identified processing steps are repeated. Otherwise, if the answer to the test at decision block 4068 is no, the method continues to another continuation terminal (“Terminal C13”).

From Terminal C11 (FIG. 4I), the method proceeds to block 4070 where the triangle is marked in the run-length-coded mask as being unavailable for further division. The method then continues to Terminal C12 and skips back to decision block 4068 where the above-identified processing steps are repeated. From Terminal C13 (FIG. 4I), the method proceeds to decision block 4072 where a test is performed to determine whether there are any available triangles to build another level. If the answer to the test at decision block 4072 is yes, the method continues to Terminal C8 and skips back to block 4050 where the above-identified processing steps are repeated. Otherwise, if the answer to the test at decision block 4072 is no, the method continues to another continuation terminal (“Terminal C14”) and further proceeds to block 4074 where the method, for each level, stores the run-length-encoded mask followed by the deviated distances for each channel. The method then continues to Terminal D.

From Terminal D (FIG. 4A), the method proceeds to a set of method steps 4005 where the method performs bit-plane transformation to produce a compressed point cloud. See FIGS. 4J-4K. From Terminal E (FIG. 4J), the method proceeds to block 4092 where the method receives a channel. Next, at block 4094, the method begins a bit-planing coding process. The method then extracts the sign from the magnitude of each coefficient at block 4096. At block 4098, taking the magnitude of all coefficients, the method builds bit-planes from them. The method further proceeds to block 4100 where taking each bit-plane and associated sign information, the method executes an encoding process. The method then extracts a context stream, a bit stream, and plane layout from the encoding process at block 4101. The method then proceeds to another continuation terminal (“Terminal E1”).

From Terminal E1 (FIG. 4K), the method proceeds to block 4102 where it takes the context stream and the bit stream and presents them to an MQ encoder. At decision block 4104, a test is performed to determine whether the user of the method 4000 has specified a maximum size for the compressed point cloud file. If the answer to the test at decision block 4104 is no, the method continues to Terminal F and terminates execution. Otherwise, if the answer to the test at decision block 4104 is yes, the method continues to block 4106 where the method decimates one or more levels of triangles from the triangular network until the size of the triangular network is below the specified maximum size. At block 4108, taking the output of the MQ encoder and the plane layout, the method performs a serialization and writes the result of the serialization to a compressed data cloud file or point cloud file. The method then continues to Terminal F and terminates execution.

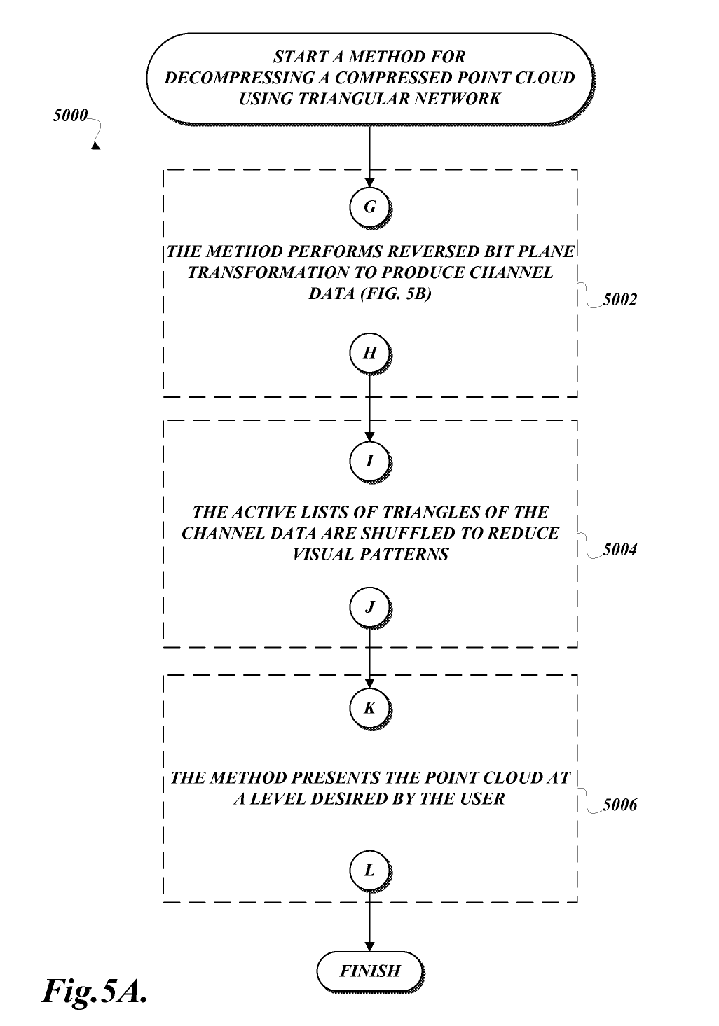

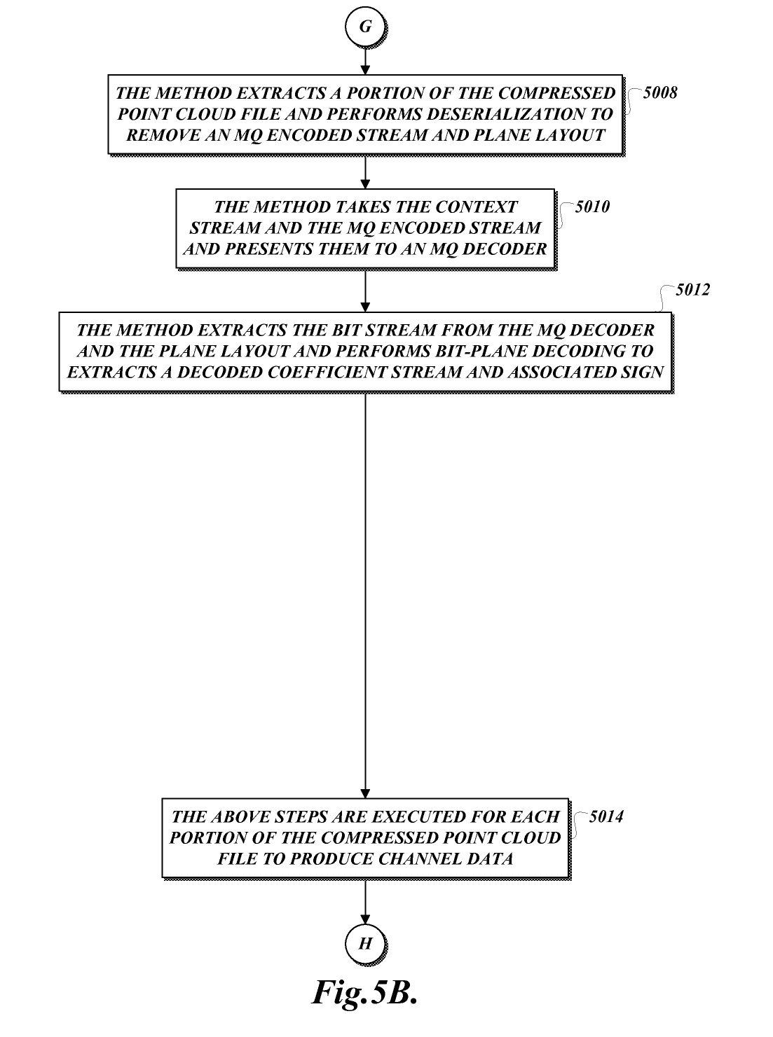

FIGS. 5A-5B illustrate a method 5000 for decompressing a compressed point cloud using the triangular network. From a start block, the method 5000 proceeds to a set of method steps 5002 defined between a continuation terminal (“Terminal G”) and an exit terminal (“Terminal H”). The set of method steps 5002 describes the performance of reversed bit-plane transformation to produce channel data. See FIG. 5B. From Terminal G (FIG. 5B), the method proceeds to block 5008 where the method extracts a portion of the compressed point cloud file and performs deserialization to remove an MQ encoded stream and plane layout. At block 5010, the method takes the context stream and the MQ encoded stream and presents them to an MQ encoder. The method then extracts, at block 5012, the bit stream from the MQ encoder and the plane layout and performs bit-plane decoding to extract a decoded coefficient stream and associated sign. At block 5014, the above steps are executed for each portion of the compressed point cloud file to produce channel data. The method then continues to Terminal H.

From Terminal H (FIG. 5A), the method 5000 proceeds to a set of method steps 5004, defined between continuation terminals (“Terminal I” and “Terminal J”). The set of method steps 5004 describes the shuffling of the active lists of triangles of the channel data to reduce visual patterns. From Terminal J (FIG. 5A), the method 5000 proceeds to a set of method steps 5006, defined between continuation terminals (“Terminal K” and “Terminal L”). The set of method steps 5006 describes the presentation of the point cloud at a level desired by the user. The method then terminates execution.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system for compressing a point cloud, comprising:
a triangular network processor configured to receive points of the point cloud, and further configured to create one or more levels of a triangular network by forming active lists of triangles, each subsequent level being formed from dividing triangles of a prior level; and
a bit-plane encoder configured to receive the triangular network to build bit planes that include a context stream, a bit stream, and plane layout to encode a compressed point cloud.

2. The system of claim 1, further comprising a level decimator configured to decimate one or more levels of the triangular network until the size of the triangular network is below a specified maximum size.

3. The system of claim 1, further comprising a shuffler configured to shuffle active lists of triangles to reduce visual patterns.

4. A method for compressing a point cloud, comprising:
transforming points of the point cloud into a triangular network that includes levels of triangles, each subsequent level being formed from dividing triangles of a prior level; and
compressing using bit-plane encoding to extract from the triangular network a context stream, a bit stream, and plane layout to encode a compressed point cloud.

5. The method of claim 4, further comprising superimposing a bounding box over the point cloud to capture a suitable point population while avoiding points at various curvatures of the point cloud for transforming points of the point cloud into the triangular network.

6. The method of claim 5, further comprising calculating a searching radius by taking the square root of a quotient the dividend of which is a size of the point population and the divisor of which is the area of the bounding box.

7. The method of claim 6, further comprising building an upper level of the triangular network by finding points closest to the searching radius as vertices to form a triangle, and continuing to find points closest to the searching radius to build one or more triangles each of which shares at least one vertex with another triangle.

8. The method of claim 7, further comprising building a lower level of the triangular network by calculating a center of mass of each triangle from the upper level and locating a point closest to the center of mass of a triangle from which three edges emanate to converge at the vertices of the triangle to divide the triangle into three triangles.

9. The method of claim 8, further storing a deviated distance which is calculated as a difference between a location of the center of mass and a location of the point closest to the center of mass.

10. The method of claim 9, further marking a triangle in a run-length-coded mask if the triangle is available for further division.

11. The method of claim 10, further decimating one or more levels of the triangular network until a size of the triangular network is below a specified maximum size.

12. A non-transitory computer-readable medium on which computer-executable instructions are stored for implementing a method for compressing a point cloud, comprising:
transforming points of the point cloud into a triangular network that includes levels of triangles, each subsequent level being formed from dividing triangles of a prior level; and
compressing using bit-plane encoding to extract from the triangular network a context stream, a bit stream, and plane layout to encode a compressed point cloud.

13. The computer-readable medium of claim 12, further comprising superimposing a bounding box over the point cloud to capture a suitable point population while avoiding points at various curvatures of the point cloud for transforming points of the point cloud into the triangular network.

14. The computer-readable medium of claim 13, further comprising calculating a searching radius by taking the square root of a quotient the dividend of which is a size of the point population and the divisor of which is the area of the bounding box.

15. The computer-readable medium of claim 14, further comprising building an upper level of the triangular network by finding points closest to the searching radius as vertices to form a triangle, and continuing to find points closest to the searching radius to build one or more triangles, each of which shares at least one vertex with another triangle.

16. The computer-readable medium of claim 15, further comprising building a lower level of the triangular network by calculating a center of mass of each triangle from the upper level and locating a point closest to the center of mass of a triangle from which three edges emanate to converge at the vertices of the triangle to divide the triangle into three triangles.

17. The computer-readable medium of claim 16, further storing a deviated distance which is calculated as a difference between a location of the center of mass and a location of the point closest to the center of mass.

18. The computer-readable medium of claim 17, further marking a triangle in a run-length-coded mask if the triangle is available for further division.

19. The computer-readable medium of claim 18, further decimating one or more levels of the triangular network until a size of the triangular network is below a specified maximum size.
